(19) United States
(12) Patent Application Publication
(10) Pub. No.: US 2026/0192226 A1
(43) Pub. Date: Jul. 9, 2026

(54) FRAME UNIT

(71) Applicant: ZEHNDER GROUP INTERNATIONAL AG, Gränichen (CH)

(72) Inventor: Jan JANSEN, Dongen (NL)

(21) Appl. No.: 19/128,529

(22) PCT Filed: Nov. 7, 2023
(86) PCT No.: PCT/EP2023/081045

§ 371 Date: May 8, 2025

(30) Foreign Application Priority Data
Nov. 14, 2022 (CH) CH001356/2022
Apr. 20, 2023 (CH) CH000412/2023

(51) Int. Cl. B01D 46/00; B01D 46/52

(52) U.S. Cl. CPC B01D 46/0005; B01D 46/0016; B01D 46/521; B01D 2265/028; B01D 2275/205; B01D 2279/50

(57) ABSTRACT

Disclosed is a frame unit for accommodation a replaceable filter element, wherein the frame unit comprises a frame comprising two longitudinal frame walls and two transversal frame walls defining a filter accommodation compartment for accommodating the filter element, wherein the frame comprises two engagement ribs each defining a groove to accommodate the respective ends of the filter element. Furthermore, the frame unit-comprising a fastener assembly for securing the filter element within the frame. The fastener assembly comprising two longitudinally opposed fasteners, wherein the fasteners are pivotably mounted to the frame and are pivotable between a closed and an open position and wherein the fasteners are in the closed position configured to form a form locking and/or force locking engagement with the frame.

### BACKGROUND

### Technical Field

The present disclosure relates generally to a frame unit, in particularly to a reusable filter frame unit for disposable filters in air passageways of Heating-Ventilation and Air-Conditioning (HVAC) systems.

### Description of the Related Art

Many conventional Heating-Ventilation and Air-Conditioning (HVAC) systems include a disposable filter. Typically, these filters are mounted in and permanently attached to a filter frame for use in a HVAC system. After a certain service life, the filters have to be replaced due to dirt and clogging. In most cases, the filter including the frame is replaced and the used filter and filter frame are disposed of. For a proper system operation and for providing the necessary filtering capacity, replacement of the filter may be necessary several times a year depending on the use and degree of fouling of the filter. All of these applications have the disadvantage that unnecessary waste and costs are generated since the filter including the frame is replaced and disposed of each time, even though only the filter is no longer functional.

### BRIEF SUMMARY

In the state of the art, filter assemblies containing a frame and a removable filter for HVAC systems are known. Typically, the reusable filter frames consist of a base and a cover between which the removable filter is installed. While offering the removing of the filter and therefore the reuse of the filter frame, these filter frames often implicate the risk, that the newly installed filter is inserted backward or incorrectly mounted to the filter frame. The consequence of an incorrect mounting is a dislocation of the filter on system startup or operation. Inadvertent dislodgement of the filter allows air to flow without filtering and may create mechanical problems to the HVAC system as well as health problems to the individuals affected. To prevent an incorrect mounting of a removable filter, these filter frames often include additional guide systems which have to engage with each pleat of the filter. However, a simple and quick replacement of the filter is not possible anymore.

Other known reusable filter frames use additional locking systems to prevent a dislodgement of the filter. These locking systems often require tools for the opening and closing the locking system.

It is an overall objective of the present disclosure to advance the state of the art regarding the reusable filter frames and filter elements. Favorably, one or more of the before-mentioned disadvantages of the prior art are overcome fully or partly.

As will become apparent in the following, the disclosure may in particular allow an easy, fast and reliable replacement of a removable filter in a reusable filter frame without the requirement of any tools and the securely remain of the filter in its designated seat in the filter frame.

In a general way, the overall objective is achieved by the subject of the independent claims. Particularly advantageous embodiments are defined by the dependent claims, as well as the overall disclosure.

In a first aspect, the overall objective is achieved by a frame unit for accommodating a replaceable filter element. The filter element comprises a plurality of pleats and the pleats extend in parallel to each other between opposite ends of the filter element in a longitudinal direction. Each pleat comprises a fold line defining a pleat tip and a pair of adjacent panels. The pleat tips may be rounded and the filter element forms either a rigid or a reversible collapsible and expandable zig-zag-pattern. The filter element may comprise two peripheral end sections and each of them includes at least one panel and one pleat tip, but typically one single pleat, wherein the peripheral end sections form the respective end of the filter element. In some embodiments, the filter element may be a filter element as described herein, in particular a filter element with a predetermined folding edge.

Furthermore, the frame unit comprises a frame. The frame comprises frame walls, which each comprise an inner surface of the frame walls and an outer surface of the frame walls and which define a filter accommodation compartment for accommodating the filter element. It is understood that the inner surface of the frame walls are typically facing each other, while the outer surfaces of the frame walls are facing away from each other. Moreover, the frame comprises two engagement ribs being along a longitudinal direction oppositely arranged to each other. Each engagement rib defines, respectively delimits, a groove. Each of the grooves extends in a transversal direction along the inner surface of at least a portion of the frame walls. That is, the groove is typically defined, respectively delimited, by the corresponding engagement rib and the inner surface of at least a portion of the frame walls. The longitudinal direction is perpendicular to the transversal direction. Furthermore, the pleat tips of the filter element extend in the transversal direction. The extension of the frame unit in the longitudinal direction is typically larger than in the transversal direction. The vertical direction is perpendicular to the transversal and to the longitudinal direction. The extension of the frame unit in the vertical direction may be referred to as the height of the frame unit and is typically smaller than the extension of the frame unit in the longitudinal and in the transversal direction.

The grooves defined by the engagement ribs may either be through-going, i.e., configured such that a through-going opening is formed between the engagement ribs and the frame walls, or it may be a blind-hole, i.e., configured such that no through-going opening is formed between the engagement ribs and the frame walls.

The frame unit additionally comprises a fastener assembly being configured for securing the filter element within the frame. The fastener assembly comprises two longitudinally opposed fasteners being each pivotably mounted to the frame. The fasteners are each pivotable between a closed position and an open position, and the fasteners are in the closed position configured to form a form locking and/or force locking engagement with the frame and in particular with the frame walls, preferably with longitudinally extending frame walls. It is clear that the form locking and/or force locking engagement of the fasteners with the frame is released when the fasteners are pivoted into the open position. The fasteners thereby allow to rapidly and reliably secure the filter element within the accommodation compartment. The force locking and/or form locking connection allows a secure engagement of the fasteners to the frame. Furthermore, the grooves allow to quickly secure the filter element to one side of the frame in the envisioned and correct manner.

In preferred embodiments, the fasteners and the frame are configured such that upon forming a form locking and/or force locking engagement to secure a filter in the filter accommodation compartment in the closed position, in particular form-locking means of the frame, respectively the frame walls, and form-locking means of the fasteners are in the closed position in direct contact with each other.

Typically, the frame comprises, or consists of, two opposing longitudinal frame walls and two opposing transversal frame walls. In typical embodiments, the frame, respectively the two opposing longitudinal frame walls and two opposing transversal frame walls, defines a through-going opening. The through-going opening is preferably configured such that the filter accommodation compartment can be accessed from two opposing sides.

The frame unit is used in particular for Heating-Ventilation and Air-Conditioning (HVAC) systems. The gas flowing through the filter element is in particular air. If appropriate however, the frame unit may also be designed to be used for accommodate any suitable filter elements designed to have any gas flowing through it.

Directional indications as used in the present disclosure are used in reference to the frame unit when the frame unit is mounted in the HVAC system, wherein the longitudinal direction extends along the longitudinal axis and defines the “length” of the frame unit, i.e., the length of the frame unit along the longitudinal axis from the bottom to the upper end of the frame unit in the assembled state. The longitudinal direction is perpendicular to the transversal direction and the vertical direction, wherein the transversal direction extends along the transversal axis and defines the “width” of the frame unit and wherein the vertical direction extends along the vertical axis and defines the “height” or the “thickness” respectively of the frame unit. Typically, the extension of the frame unit along the longitudinal direction is larger than along the transversal direction and in particular, the extension of the frame unit along the transversal direction is larger than along the vertical direction.

The frame or the filter accommodation compartment respectively is configured to accommodate a filter element of a HVAC system. Typically the frame and/or the filter accommodation compartment may have a rectangular contour. Typically, the frame is configured such that air can flow in a vertical direction trough the frame unit via the accommodated filter element. Furthermore, the filter accommodation compartment substantially matches the shape and dimension of the respective filter element so that the air is not allowed to directly bypass the filter element.

The two engagement ribs are along the longitudinal direction oppositely arranged to each other, in particular diametrically oppositely arranged to each other. Each of the two engagement ribs defines a groove. Each of the grooves may continuously extend in parallel to the inner surface of the corresponding frame wall over the entire width of the filter accommodation compartment. The grooves are each configured to receive at least one panel and a pleat tip of a filter element, particularly only one single pleat of the respective peripheral end section of the filter element. Furthermore, the extension of the two engagement ribs in vertical direction typically does not extend beyond the extension of the filter frame in the vertical direction.

In some embodiments, the distance between each engagement rib and the frame wall, particularly the transversal frame wall is between 1 mm and 65 mm, in particular between 5 mm and 20 mm, more particular between 10 mm and 20 mm. This distance is to be considered as the groove width of the corresponding groove.

When the respective peripheral end section of the filter element is mounted in the respective groove, the filter element extends over the entire filter accommodation compartment of the frame. If the filter element is an expandable zig-zag-pattern filter element, the filter pleats expand—while accommodated in the frame unit—with a uniform spacing of the pleats over the entire filter accommodation compartment.

In some embodiments, the frame may contain an additional lug mounted to a portion of the outer surface of the frame walls. The additional lug indicates the upper end of the frame unit and therefore the correct mounting direction of the filter arrangement into an HVAC system. On the other hand, the lug is used to facilitate removal of the filter arrangement from the HVAC system to change the filter element. Further, the inner surface of the frame walls along the longitudinal direction may provide a sealing surface for side edges of the filter element. For example, the sealing surface may be made from an elastomeric material. The inner surface of the frame walls may in some embodiments have at least the same extension in vertical direction as the associated filter element. Such designed inner surface of the frame walls prevent air from bypassing the filter element in vertical direction and therefore ballooning the filter element out of the frame. Typically, extension in vertical direction of the inner surface of the frame walls along the longitudinal direction and the associated filter element are essentially equal and therefore in flush to each other.

The two fasteners of the fastener assembly are pivotably mounted to the frame and in particular, may be pivotably mounted to the inner surface of the frame walls or to the outer surface of the frame walls. The two fasteners are pivotable between the closed and the open position. In some embodiments, the pivoting axis along which the corresponding fastener us pivotable between the open position and the closed position extends in the transversal direction. Typically, the open position allows the filter element to be installed in or removed from the frame unit and in the closed position, the two fasteners are configured to form a form locking and/or force locking engagement with the frame and, in the mounted state of the filter element in the filter unit, to secure the filter element within the filter accommodation compartment. In the closed position, each of the two fastener extends in longitudinal direction and, in the mounted state of the filter element in the filter unit rests on the pleat tips of the filter element. The mounted state refers to the state in which a filter element is accommodated in the filter accommodation compartment and in which the fasteners are in the closed position.

The extension in the longitudinal direction in the closed position of the two fasteners depends on the overall extension of the frame unit in longitudinal direction. In some embodiments, the extension in the longitudinal direction is dimensioned in such a way that, in the mounted state, the two fasteners securely hold the filter element within the filter accommodation compartment of the frame.

In some embodiments, the extension of the two fasteners in the longitudinal direction is dimensioned in such a way that the two fasteners do not overlap in the closed position. In some embodiments, the extension in the longitudinal direction is dimensioned in such a way that each of the two fasteners extends in the closed position over the respective engagement rib of the frame (i.e., one of the two engagement ribs) and therefore over the grooves which are configured to receive the respective peripheral end section of the filter element.

The frame and in particular the frame walls, may in some embodiments comprise form locking means. These form locking means may be arranged at a portion of the inner surface of the frame walls or at a portion of the outer surface of the fame walls along the longitudinal direction. In some embodiments, each of the two fasteners also comprises form locking means. Typically, the form locking means of the frame and the form locking means of the fasteners correspond to each other. In some embodiments, the corresponding form locking means are a tongue and a recess to form a tongue and recess connection. The tongues may be arranged at each of the two fasteners and the corresponding recesses at the frame or vice versa.

In some embodiments, each fastener comprises one or more form locking means. The form locking means may for example be male form locking means, such as a tongue, or female form locking means, such as a recess.

In preferred embodiments, the frame walls comprise at least one, particularly at least two, form-locking means, in particular, recesses and the two fasteners comprises at least one, particularly at least two, form locking means, i.e., corresponding form locking means, in particular tongues. It is understood that the term “corresponding” is in this case understood as a form locking means which can engage with another form-locking means, i.e., its corresponding form locking means, to form a releasable form-locking engagement. The form locking means may for example be male form locking means, such as a tongue, or female form locking means, such as a recess. Preferably, one of the form locking means of the frame walls or the fasteners is/are male form locking means, while the other one of the form locking means of the fasteners or the frame walls is/are female form locking means.

Preferably, the form-locking means of the frame walls are arranged on the inner surface of the frame walls. That is, the form locking means on oppositely arranged frame walls are facing each other. This allows to bring the fasteners closer to the filter arranged inside the filter accommodation compartment and thereby improves the filter fixation in the filter accommodation compartment.

The frame walls comprising the form-locking means are typically longitudinal frame walls. That is, they extend in the longitudinal direction of the frame unit.

In particular embodiments at least two frame walls, comprise each at least one, particularly at least two, form locking means, in particular, recesses and each of the two fasteners comprises at least one, particularly at least two, form-locking means, i.e., corresponding form-locking means, in particular tongues. In certain embodiments, the two form-locking means of each fastener are oppositely arranged to each other, e.g., on opposing sides of the fastener.

In some embodiments, one or more of the frame walls, in particular two frame walls, each define at least one, particularly two, notches.

The frame walls defining the notches are typically longitudinal frame walls.

In some embodiments the frame walls, which comprise at least one, particularly at least two, form-locking means define at least one, particularly two notches. Preferably each notch is arranged above, i.e., vertically above, one of the form-locking means of the frame walls. Thus above each form locking means of the frame walls there is in such embodiments a notch arranged above the form-locking means. In particular, the form locking means of the frame walls may be recesses. The notches are typically each defined by a section of the corresponding frame wall which has a smaller height than the rest of the corresponding frame wall. The notches allow a user to securely grip the fastener and release the form locking engagement thereby easily bringing the fastener from the closed position into the open position.

The notches typically penetrate, in particular along the transversal direction, through the frame walls.

In some embodiments, the notches may in the cross-section, in particular in the cross-section along the longitudinal direction and perpendicular to the transversal direction be rectangular or curved, of have the shape of a segment of a circle.

In certain embodiments, each fastener comprises at least one, in particular two, fastener projections.

In particular embodiments, the fastener projections and the notches defined by the frame walls are configured such that in the closed position, each fastener projection is accommodated in one of the notches. In certain embodiments, each fastener projection is configured such that it protrudes from the frame walls in the closed position. That is, if the fastener is in the closed position and the fastener projection is accommodated in the notch, it protrudes, in particular along the transversal direction, from the frame wall. Typically, the fastener projections and the notches are configured such that the fastener projection can be introduced into the notches when the fastener is moved from the open position into the closed position without deforming the notches or the fastener projections. This is because the notches are vertically open.

In certain embodiments, in which each fastener comprises at least one, in particular two, form-locking means, such as tongues, there may be arranged one fastener projection as outlined above, above each form-locking means.

The fastener projections may preferably all be arranged on the outer sides of the fastener side walls as described herein further below.

In some embodiments, the two fasteners are designed as flaps, wherein each of the flaps is pivotably mounted to the frame and is pivotable between the closed and open position. In certain embodiments, the recesses are typically arranged at the portions of the inner or outer surface of the frame walls along the longitudinal direction and the corresponding tongues are arranged at each of the two flaps. Preferably, each flap contains two tongues. The tongues on each flap are opposing each other in the transversal direction and, in the closed position, extend in the longitudinal direction and in the vertical direction.

In some embodiments, the frame additionally comprises at least one support web, in particular at least one longitudinal support web and/or at least one transversal support web. Typically, the at least one support web is a planar bearing surface which is designed to support the filter element in the flow direction of the airflow. Typically, the at least one support web does not extend into the filter accommodation compartment in the vertical direction, but may therefore at least partially define the filter accommodation compartment. Moreover, in some embodiments, the at least one support web may be arranged centrally and perpendicularly to the inner surface of the frame walls in the longitudinal and/or transversal direction.

In some embodiments, the frame comprises two longitudinal support webs. In such embodiments, the two longitudinal support webs are preferably arranged directly and continuously to the inner surface of the frame walls in the longitudinal direction.

In some embodiments, the frame comprises three longitudinal support webs. In such embodiments, the longitudinal support webs are typically arranged equally spaced to each other in transversal direction, wherein two of the three longitudinal support webs may be arranged directly and continuously to the inner surface of the frame walls in the longitudinal direction. The remaining longitudinal support web may be arranged in parallel to the other two support webs and may be arranged between them.

In some embodiments, the frame comprises at least one, at least two or at least three transversal support ribs. The at least one transversal support rib may be present in addition to or as an alternative to any longitudinal support ribs. Typically, at least one of the transversal support ribs is arranged centrally to the inner surface of the frame walls in longitudinal direction and extends in the vertical direction into the filter accommodation compartment. The transversal support rib is an additional support to the filter element in a mounted state in the frame unit. In preferred embodiments, the transversal support rib may engage with the predetermined folding edge of the respective filter element. The vertical extension of the transversal support rib, i.e., its height, does not extend beyond the extension of the frame in vertical direction. Preferably, the height of the transversal support rib is equal or smaller than the height of the frame. In certain embodiments, the height of the transversal support rib is greater than the height of any of the longitudinal or transversal support webs.

In some embodiments, the frame comprises two mounting rails opposing each other and continuously extending in the longitudinal direction along the outer surface of the frame walls. The mounting rails are configured to fasten the frame unit in a Heating-Ventilation and Air-Conditioning system. The two mounting rails are configured to be arranged with the mounting structure of the HVAC system such that air bypassing the filter element unfiltered is prevented. Typically, the mounting rails are guide rails for facilitating installation and removal of the filter arrangement to the corresponding counter mounting structure of an HVAC system. Alternatively, other mounting structures may be used, such as clamps or screws, which are suitable to engage the frame unit or the filter arrangement respectively with the mounting structure of the HVAC system in such a way to prevent air from bypassing the filter element unfiltered.

Typically, the frame, the at least one support web, the at least one transversal support rib and/or the mounting rails are integrally formed. In some embodiments, the frame, the at least one support web, the at least one support rib and/or the mounting rails are made from an injected molded polymer. Alternatively, the frame, the at least one support web, the at least one support rib and the mounting rails may also be made from any other suitable material and may be realized as separate or partly separate parts that are mounted to each other.

In some embodiments, the fasteners of the fastener assembly each comprise a projection rib to engage with the filter element between two neighboring panels in the closed position. In the closed position of the two fasteners, the two projection ribs are along the longitudinal direction oppositely arranged to each other. The projection ribs may be arranged at any position of the fastener in the longitudinal direction, but are preferably arranged so that they extend longitudinally in the closed position beyond the engagement ribs and therefore beyond the grooves of the frame.

The extension of the projection ribs in the transversal direction may in some embodiments be a continuous extension or a partial extension.

Furthermore, the extension of the projection ribs in the vertical direction are designed to engage between two neighboring panels of the filter element and thus may support holding the filter element in a mounted state in the filter accommodation compartment.

In some embodiments, the fastener assembly comprises locking clips being arranged at the fasteners and being configured to engage with the outer surface of the frame walls in the longitudinal direction in the closed position. Typically, two locking clips are arranged at each fastener. The locking clips may be releasably connected to the fasteners by a hinge and are pivotable between a closed and an open position. Typically, if there are two locking clips arranged at each fastener, the two locking clips are along the transversal direction oppositely arranged to each other. In some embodiments, the pivoting axis of each locking clip extends in the longitudinal direction of the frame unit. Thus, the pivoting axis of each locking clip is typically essentially perpendicular to the pivoting axis of each fastener (i.e., the pivoting axis of each fastener with respect to the frame).

In some embodiments, the locking clips are each configured to encompass and/or engage with a portion of the frame, in particular of a longitudinal frame wall. Preferably, the locking clips are each configured to encompass and/or engage with a portion of the outer surface of a longitudinal frame wall.

In some embodiments, the fastener assembly is configured to retain each opposite end of the filter element in the respective groove. In particular, the fastener assembly is configured such that the peripheral end section of the filter element, which typically includes one single pleat or multiple pleats, is held and secured in the groove of the frame.

In some embodiments, each fastener comprises a fastener frame. In certain embodiments, the fastener frame of each fastener defines a through-going openings. The through-going opening is configured such that in closed position the filter element is at least partially uncovered by the extension of the fastener in longitudinal direction. Typically, the ratio of the total open area defined by the through-going opening of a fastener to the total surface area defined by the outer periphery of the fastener is between 75% to 99%, preferably between 85% and 98%, more preferably between 90% and 95%. Such embodiments prevent blocking of the airflow through the filter element at the positions of the fastener. This allows to provide a fastener which extends relatively far along the longitudinal direction and thus enables a reliable securing of the filter, while concomitantly essentially not reducing the filter surface.

In some embodiments, each fastener frame comprises at least two opposing fastener side walls. Preferably, the two fastener side walls are extending in parallel to each other. The fastener side walls of each fastener frame are typically arranged at opposite ends of the fastener frame. Furthermore, each of the two opposing extending fastener side walls comprises an inner side and an outer side. The inner sides of the two fastener side walls may typically face each other. In some embodiments, the inner side of each fastener side wall may form an inner side surface and the outer side of each fastener side wall may form an outer side surface. The outer side surface and the inner side surface are preferably exposed to the environment.

In certain embodiments in which each of the two fasteners comprises at least two form locking means, such as two tongues, one form locking means may be arranged on one of the fastener side walls and one form locking means may be arranged on the other of the fastener side walls. In particular, the form locking means may be arranged on the outer side of each fastener side wall.

In some embodiments, the fastener frame of each fastener may also comprise the projection rib of the fastener. The projection rib may in such embodiments preferably extend between the two fastener side walls. In certain embodiments, the projection rib may be arranged transverse to, in particular perpendicular to, the two fastener side walls. Preferably, the fastener frame defines a gap between the projection rib and each one of the frame side walls. The corresponding two gaps are configured to accommodate in the closed position longitudinally extending filter side walls.

In some embodiments, the total surface area defined by the periphery of each fastener is between 25 to 550 cm², in particular between 100 to 300 cm².

In some embodiments, the ratio between the extension of each fastener element in the longitudinal direction in the closed position (i.e., its length) and the total length of the frame unit is between 5% and 25%, in particular between 10% and 20%.

To increase the stability of the fastener frame and therefore of the fastener, the fastener frame may comprise a web, i.e., a strut or the like, to divide the through-going opening into two sections, wherein the web may extend in longitudinal direction or in transversal direction.

In some embodiments, each fastener is pivotably mounted to the frame by a pivot hinge. In particular, each fastener may be pivotably mounted to the frame by two oppositely arranged pivoting hinges. The pivots of the pivot hinge may be arranged at the fasteners and corresponding recesses may be arranged at the frame wall or vice versa. In such embodiments, the fasteners are releasably mounted to the frame and therefore replaceable if necessary.

In some embodiments, each fastener is mounted to the inner surface of the frame walls, in particular the inner surface of the longitudinal frame walls. Typically, in such embodiments each fastener is pivotably mounted to the frame by a pivot hinge, wherein the pivots may arranged at the fasteners and the corresponding recesses at the surface of the frame wall or vice versa. In such embodiments, the fasteners are pivotable between a closed position and an open position, wherein the angle between the closed and the open position is essentially an 90° angle.

In a second aspect, the overall objective is achieved by the use of a filter element, such as for example a filter element as described herein or any other suitable filter element, in a frame unit as described in any of the embodiments herein, in particular with respect to the first aspect of the disclosure. The filter element particularly comprises a plurality of pleats, the pleats extend in parallel to each other between the opposite ends of the filter element, wherein each pleat includes a fold line defining a pleat tip and a pair of adjacent panels. Furthermore, the filter element may include a predetermined folding edge. The predetermined folding is typically configured for folding the filter element.

In some embodiments, the filter element comprises a top surface and a bottom surface. The pleat tips define the planar top surface and the planar bottom surface. In certain embodiments, the predetermined folding edge extends from the bottom surface towards the top surface. However, the predetermined folding edge does not protrude completely through the filter element from the bottom surface to the top surface.

In some embodiments, the predetermined folding edge is configured such that the filter element can be folded along the predetermined folding edge such that the top surface is divided into two half portions wherein the two half portions contact and/or rest on each other in the folded configuration. It is understood that the term “configured to be folded” or “configured for folding” and the like means that the filter element can be repeatedly folded and unfolded along the predetermined folding edge without destroying the filter element, i.e., without tearing the filter element.

The predetermined folding edge is an edge at which the filter element can be folded, respectively at which folding is facilitated as compared to other portions of the filter element lacking such a predetermined folding edge.

In a third aspect, the overall objective is achieved by a filter arrangement. The filter arrangement comprises a frame unit according to any of the embodiments as described herein, in particular with respect to the first aspect of the disclosure, and a filter element. The filter element is accommodated within the filter accommodation compartment of the filter frame. Furthermore, the filter element may comprise a predetermined folding edge and include a plurality of pleats. The pleats extend in parallel to each other between opposite ends of the filter element and each pleat includes a fold line defining a pleat tip and a pair of adjacent panels. The pleat tips may be rounded and the filter element forms zig-zag-pattern. The zig-zag pattern may either be rigid or a reversibly collapsible and expandable. The filter element includes two respective peripheral end sections and each of them includes at least one panel and one pleat tip, in particular one single pleat or multiple pleats, wherein the peripheral end sections form the respective end of the filter element. The filter element is held by the frame unit.

In some embodiments, the fastener assembly retains each of the opposite ends of the filter element in the respective groove. The fastener assembly securely retains the peripheral end section of the filter element in the groove and this the filter element in the filter accommodation compartment of the frame and prevents air from flowing unfiltered around the filter element and/or ballooning the filter element out of the frame.

In some embodiments, each of the respective peripheral end sections of the filter element typically comprises only one filter pleat, which are each pinched by the respective fastener and its projection into the respective groove of the frame. Alternatively, each of the respective peripheral end sections of the filter element may include at least a panel that is pinched into the respective groove by the fastener and its projection.

In a fourth aspect, the overall objective is achieved by the use of a frame unit or a filter arrangement according to any of the embodiments as described herein in a Heating-Ventilation and Air-Conditioning system in accordance with the present disclosure, in particular for filtering air.

In a fifth aspect, the overall objective is achieved by a kit of parts comprising a filter arrangement according to any of the embodiments as described herein, in particular with respect to the third aspect, and one or more filter elements, such as the filter elements as disclosed in any of the embodiments herein. The kit comprises one or more filter elements to allow replacement of the filter element after a period of use.

### BRIEF DESCRIPTION OF THE SEVERAL VIEWS OF THE DRAWINGS

FIG. 1 shows a schematic top view of a filter arrangement according to an embodiment of the disclosure;

FIG. 2a shows a schematic side view of the sectional plane (A-A) of the filter arrangement according to FIG. 1;

FIG. 2b shows an enlarged section of the filter arrangement of FIG. 2a.

FIG. 3 shows a schematic top view of a frame unit in a closed position according to an embodiment of the disclosure;

FIG. 4 shows a schematic perspective view of the frame unit according to FIG. 3 in an open position;

FIG. 5 shows a schematic view of a filter element for a frame unit according to an embodiment of the disclosure;

FIG. 6 shows a perspective view of a filter arrangement with a frame unit according to another embodiment of the disclosure as well as an enlarged view of a section thereof;

FIG. 7 shows a perspective view of a frame unit according to another embodiment of the disclosure;

FIG. 8 shows a cross section along the transversal direction and perpendicular to the longitudinal direction of the frame unit shown in FIG. 7.

### DETAILED DESCRIPTION

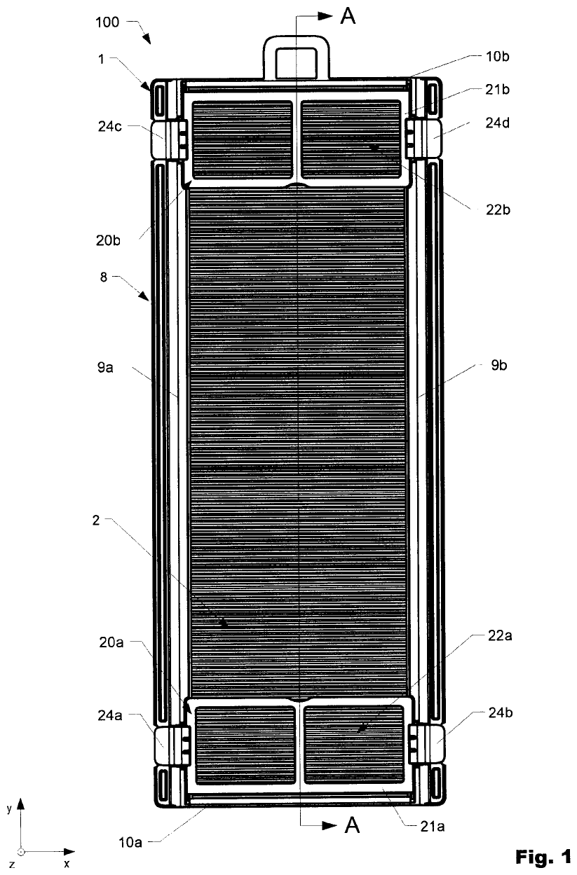

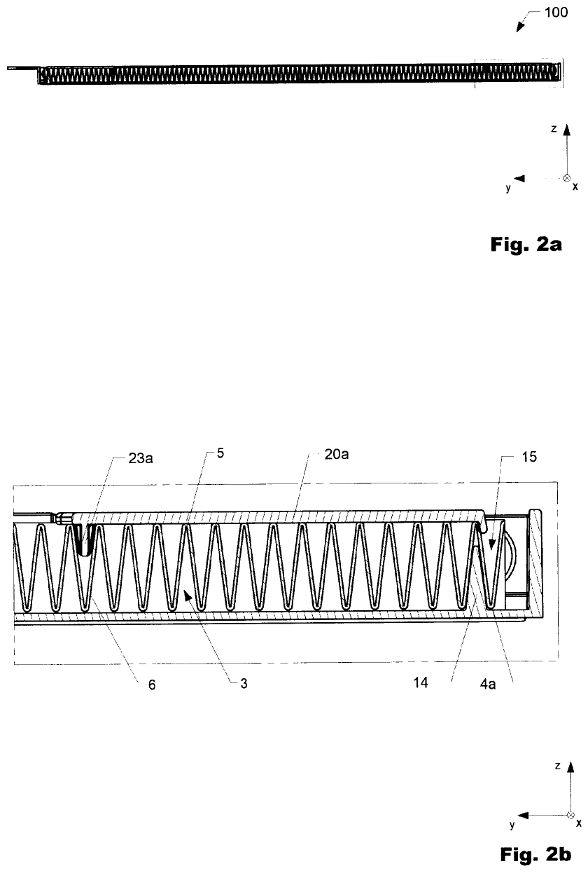

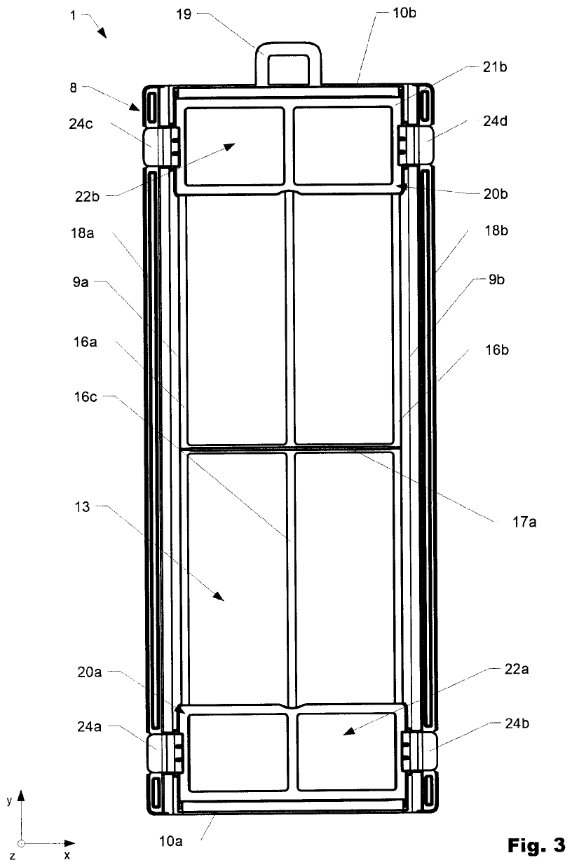

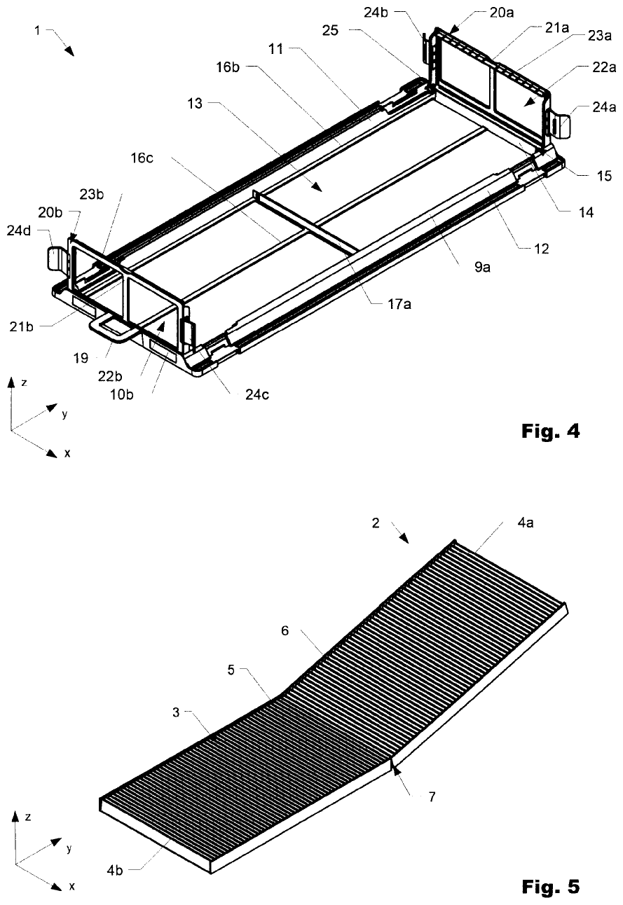

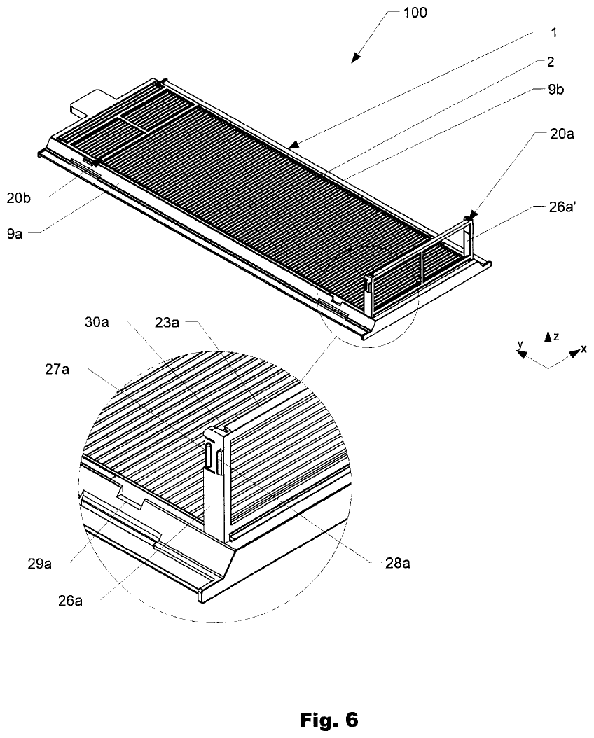

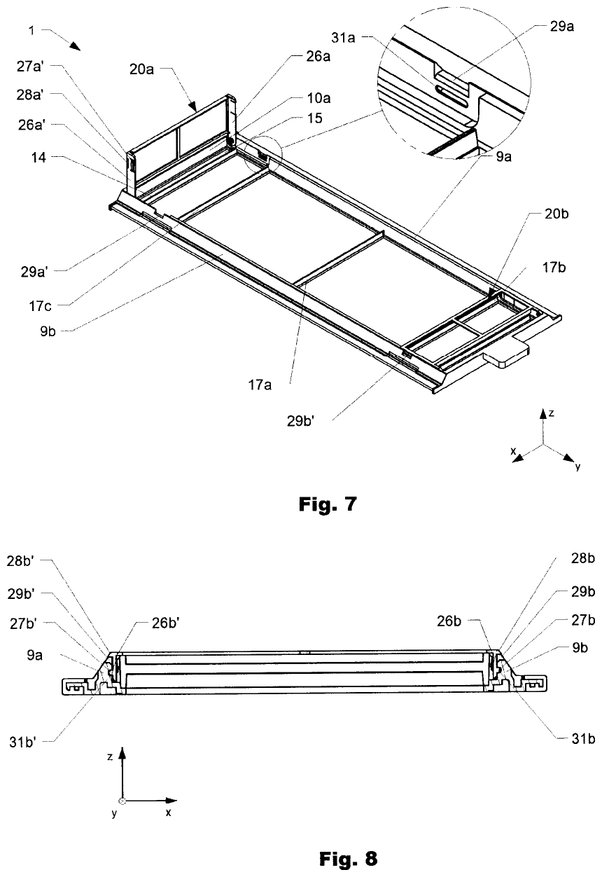

FIG. 1, FIGS. 2a and 2b show an embodiment of a filter arrangement 100 according to the disclosure. FIG. 1 shows the filter arrangement 100 in a schematic top view and FIG. 2 shows the sectional plane A-A in a schematic side view of the filter arrangement 100. FIG. 3-FIG. 4 show an embodiment of a frame unit 1 according to the disclosure. FIG. 3 shows the frame unit 1 in a closed position and FIG. 4 shows the frame unit 1 in an open position. FIG. 5 shows a filter element 2 for a frame unit 1 according to the disclosure. FIG. 6 shows a perspective view of filter arrangement 100 according to another embodiment of the disclosure, FIG. 7 depicts frame unit 1 as it is used in filter arrangement 100 shown in FIG. 6 and FIG. 8 a cross section of the frame unit.

The shown filter arrangement 100 in FIG. 1 comprises a frame unit 1 and a filter element 2. The filter element 2 comprises a plurality of pleats. The pleats extend in parallel to each other in the longitudinal direction y between two peripheral end sections of the filter element 2. The peripheral end sections define the opposite ends of the filter element 2. Each pleat comprises a fold line defining a pleat tip and a pair of adjacent panels. It is clear that typically two adjacent tips share a corresponding panel. The frame unit 1 comprises a frame 8. Said frame 8 comprises two longitudinal frame walls 9a,b which extend in the longitudinal direction y and two transversal frame walls 10a,b which extend in the transversal direction x. Each of the frame walls comprise an inner surface and an outer surface. The frame walls 9a,b, 10a,b define a filter accommodation compartment in which the filter element 2 is accommodated. In this embodiment, the inner surface of the two longitudinal frame walls 9a,b have the same extension in the vertical direction z as the filter element 2. Therefore, the inner surface of the two longitudinal frame walls 9a,b provide a sealing surface for side edges of the filter element 2 along the longitudinal direction y. Furthermore, the frame 8 comprises two engagement ribs. The engagement ribs are oppositely arranged to each other along the longitudinal direction y. Each of the engagement ribs define a groove. The grooves continuously extend in the transversal direction x in parallel to the inner surface of the two transversal frame walls 10a,b.

Frame unit 1 comprises a fastener assembly for securing filter element 2 within the filter accommodation compartment of frame 8. In this embodiment, the fastener assembly comprises two fasteners 20a,b. The fasteners 20a,b are opposed to each other in the longitudinal direction y. Said fasteners 20a,b are pivotably mounted to the frame 8. The two fasteners 20a,b are shown in the closed position and each of them forms a form locking and force locking engagement with frame 8. In this embodiment, the ratio between the extension of each fastener 20a,b in the longitudinal direction y in the closed position (i.e., its length) and the total length of the frame 8 is around 15%. As shown in FIG. 1, each of the two fasteners 20a,b comprises a fastener frame 21a,b. Each fastener frame 21a,b defines a through-going opening 22a,b. In this embodiment, each of the fastener frames 21a,b comprises an additional frame web to increase the stability of the fastener frame 21a,b. The frame webs extend in the closed position of the fasteners 20a,b in the longitudinal direction y. Each of the frame webs is arranged centrally, i.e., divides the through-going openings 22a,b into two equally sized sections. In this embodiment, the ratio of the total area defined by the through-going opening 22a,b of a fastener 20a,b to the total surface area defined by the outer periphery of the fastener 20a,b is 75%. This means, in the closed position, the filter element 2 is 75% uncovered by the extension of the fasteners 20a,b in the longitudinal direction y and therefore prevent blocking the airflow through the filter element 2 at the positions of the fasteners 20a,b. Furthermore, in this embodiment, the fastener assembly comprises four locking clips 24a,b,c,d. Two locking clips 24a,b,c,d are pivotably mounted on each fastener 20a,b. The two locking clips 24a,b,c,d of the fasteners 20a,b are oppositely arranged to each other in the transversal direction x. The locking clips 24a,b,c,d are shown in a closed position and each encompass/engage and form a form locking and a force locking connection with a portion of each of the outer surface of the longitudinal frame walls 9a,b.

FIG. 2a shows a sectional view through the sectional plane A-A of the filter arrangement 100. FIG. 2b shows an enlarged section of FIG. 2a. For clarity purpose only one pleat 3, one pleat tip 5 and one panel 6 is referenced. Furthermore, it is clear for the skilled person in the art, that the description herein also applies to the second fastener, which is not shown in detail. It can be seen that one of the two opposite ends 4a, i.e., one peripheral end section, of the filter element is accommodated within groove 15. Groove 15 is defined by the engagement rib 14. In this embodiment, the peripheral end section includes one single pleat 3. The fastener 20a extends in the longitudinal direction y and rest in its closed position on pleat tips 5 of the filter element. As it shown in FIG. 2b, the fastener 20a extends in the longitudinal direction y over the engagement rib 14 and therefore beyond groove 15. Furthermore, as shown in FIG. 2b, the fastener 20a comprises projection rib 23a. The projection rib 23a engages in its closed position between two neighboring panels 6 of the filter element 2. Thereby projection rib 23a securely holds filter element 2 within the filter accommodation compartment of the filter frame.

FIG. 3 shows an embodiment of frame unit 1 according to the disclosure in the closed position and FIG. 4 shows frame unit 1 in the open position. The frame unit 1 comprises a frame 8. Frame 8 comprises two longitudinal frame walls 9a,b which extend in the longitudinal direction y and two transversal frame walls 10a,b which extend in the transversal direction x. Each of the frame walls 9a,b, 10a,b comprises an inner surface 11 and an outer surface 12. The frame walls 9a,b, 10a,b define a filter accommodation compartment 13. Furthermore, frame 8 comprises two engagement ribs 14. The engagement ribs 14 are oppositely arranged to each other along the longitudinal direction y. Each of the engagement ribs defines a groove 15. Grooves 15 continuously extend in the transversal direction x in parallel to the inner surface 11 of the two transversal frame walls 10a,b. As shown, frame 8 comprises three longitudinal support webs 16a,b,c. The longitudinal support webs 16a,b,c are planar bearing surfaces to support a filter element in the flow direction of the airflow. In this embodiment, two longitudinal support webs 16a,b are arranged directly and continuously in longitudinal direction y to the inner surface 11 of the two longitudinal frame walls 9a,b. The third longitudinal support web 16c, is arranged between the two longitudinal support webs 16a,b and extends in parallel to and spaced apart from them. Moreover, the longitudinal support web 16c is arranged centrally and perpendicularly to the inner surface 11 of the transversal frame walls 10a,b. Furthermore, in this embodiment, frame 8 comprises one transversal support rib 17a. The transversal support rib 17a is arranged centrally to the inner surface 11 of longitudinal frame walls 9a,b. Transversal support rib 17a extends in vertical direction z towards filter accommodation compartment 13. The extension in vertical direction z of the transversal support rib 17a, i.e., its height, is less than the extension of the inner surface 11 of the frame walls 9a,b, 10a,b. As shown in this embodiment, frame 8 further comprises two mounting rails 18a,b. Mounting rails 18a,b oppose each other. Moreover mounting rails 18a,b continuously extend in the longitudinal direction y along the outer surface 12 of the longitudinal frame walls 9a,b. In this embodiment, mounting rails 18a,b are designed as guide rails. Furthermore, frame 8 comprises a lug 19. The lug is mounted to a portion of the outer surface 12 of transversal frame wall 10b. On the one hand, lug 19 is used to indicate the upper end of the frame unit 1 and therefore the correct mounting direction of the filter arrangement into an HVAC system. On the other hand, lug 19 is used to facilitate removal of the filter arrangement out of the HVAC system to change the filter element.

Furthermore, frame unit 1 comprises a fastener assembly. The fastener assembly comprises two fasteners 20a,b. Each of the two fasteners 20a,b comprises a fastener frame 21a,b. The fastener frames 21a,b define a through-going opening 22a,b. In this embodiment, the fastener assembly comprises four locking clips 24a,b,c,d. Two locking clips 24a,b,c,d are mounted on each fastener 20a,b. The two locking clips 24a,b,c,d of each fastener 20a,b are oppositely arranged to each other in the transversal direction x. The locking clips 24a,b,c,d are releasably connected to the fasteners 20a,b by a hinge. The locking clips 24a,b,c,d are pivotable between a closed and an open position. Furthermore, in this embodiment, each of the two fasteners 20a,b comprises a projection rib 23a,b. The projection ribs 23a,b extend continuously in transversal direction x. As shown in FIG. 4, fasteners 20a,b are mounted to inner surface 11 of longitudinal frame walls 9a,b. Each fastener 20a,b is mounted to the frame, respectively to inner surface 11 of longitudinal frame walls 9a,b by two pivot hinges 25. The pivots are arranged at inner surface 11 of the longitudinal frame walls 9a,b and the hinges at the fasteners 20a,b. As shown in FIG. 3 and FIG. 4, fasteners 20a,b are pivotable with a 900 angle between the closed and the open position.

FIG. 5 shows a filter element 2 for a frame unit according to the disclosure. The filter element 2 comprises a predetermined folding edge 7, a plurality of pleats 3, wherein the pleats 3 extending parallel to each other between the two opposite ends 4a,b of the filter element in longitudinal direction. Each pleat 3 comprises a fold line defining a pleat tip 5 and a pair of adjacent panels 6. For clarity purpose only one pleat 3, one pleat tip 5 and one panel 6 is referenced.

FIG. 6 shows a perspective view of filter arrangement 100 according to another embodiment of the disclosure. Compared with the embodiment shown in FIG. 1 the filter arrangement 100 shown in FIG. 6 differs particularly in frame unit 1. Frame unit 1 comprises two fasteners 20a and 20b, which can be moved from a closed position into an open position. As can be seen from FIG. 6, fastener 20a is currently in the open position and fastener 20b is in the closed position in which it maintains filter 2 within the filter accommodation compartment. Frame unit 1 also comprise frame walls with two longitudinal frame walls 9a and 9b. Each fastener 20a and 20b comprises a fastener frame. Illustrated with respect to fastener 20a, it can be seen that the fastener frame comprises in this embodiment two oppositely arranged fastener side walls 26a and 26a′ and projection rib 23a. It can be seen in the enlarged view that the fastener frame, respectively projection rib 23a and fastener side wall 26a, defines gap 30a between projection rib 23a and fastener side wall 26a. This gap may accommodate in the closed position of the fastener a longitudinally extending filter side wall. Fastener 20a comprises form locking means 27a which in this embodiment is a tongue, i.e., a male form locking means. As can be seen, the form locking means 27a is arranged on the outer side of fastener side wall 26a. As illustrated for example in FIG. 7, longitudinal frame walls 9a and 9b comprise corresponding form locking means (see FIG. 7, 31a), which are in these embodiments recesses, i.e., female form locking means. It is generally understood that the form locking means of the fasteners and the form locking means of the frame walls are configured to form a releasable form locking engagement. Fastener 20a further comprises fastener projection 28a which is arranged in the vertical direction in the closed position arranged above form locking means 27a.

Furthermore, longitudinal frame walls 9a and 9b each define two notches, such as notch 29a. As can be seen from the detailed view, upon pivoting fastener 20a from the open position into the closed position, fastener protrusion 28a is inserted into notch 29a such that is accommodated in notch 29a.

FIG. 7 shows frame unit 1 as it is used in filter arrangement 100 shown in FIG. 6. It can be seen that longitudinal frame walls 9a and 9b comprise on the inner surfaces form locking means, such as form locking means 31a (see the detailed view of FIG. 7) which in this embodiment is a female form locking means, such as a recess. Furthermore it can be seen that the frame unit 1 comprise three parallel extending transversal support ribs 17a, 17b and 17c, but in contrast to frame unit 1 shown in FIG. 3 no central longitudinal support web (see FIG. 3, 16c). It can be seen from the detailed view that notch 29a defined by longitudinal frame wall 9a is arranged vertically above (i.e., in z-direction above) form locking means 31a. It can further be seen that engagement rib 14 defines groove 15 between engagement rib 14 and transversal frame wall 10a. In this embodiment, the groove is through-going, however it is also possible that it is configured as a blind hole.

FIG. 8 shows a cross-sectional view of frame unit 1 shown in FIG. 7 in the transversal direction x and perpendicular to longitudinal direction y. The cross section extends through fastener 20b being in the closed position. It can be seen that male form locking means 29b and 29b′ form a form locking engagement with corresponding female form locking means 31b, 31b′. Furthermore it can be seen that the fastener protrusions 28b and 28b′ are accommodated in notches 27b, 27b′ which are defined by longitudinal frame walls 9a and 9b. Thereby, a user can easily grip fastener 28 at a fastener protrusion 28b, 28b′ and release the form locking engagement with the frame walls by pulling the fastener protrusion in the vertical direction.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A frame unit for accommodating a replaceable filter element, wherein the filter element comprises a plurality of pleats, the pleats extending in parallel to each other between opposite ends of the filter element in a longitudinal direction, wherein each pleat comprises a fold line defining a pleat tip and a pair of adjacent panels; wherein the frame unit further comprises:
a frame comprising frame walls which each comprise an inner surface of the frame wall and an outer surface of the frame wall, wherein the frame walls define a filter accommodation compartment for accommodating the filter element, wherein the frame comprises two engagement ribs being along a longitudinal direction oppositely arranged to each other and which each define a groove which extends in a transversal direction along the inner surface of at least a portion of the frame walls;
a fastener assembly for securing the filter element within the frame, the fastener assembly comprising two longitudinally opposed fasteners being pivotably mounted to the frame, wherein the fasteners are pivotable between a closed position and an open position, and wherein the fasteners are in the closed position configured to form a form locking and/or force locking engagement with the frame.

2. The frame unit, according to claim 1, wherein the frame additionally comprises at least one longitudinal support web and/or at least one transversal support web.

3. The frame unit according to claim 1, wherein the frame comprises at least one transversal support rib.

4. The frame unit according to claim 1, wherein the frame comprises two mounting rails opposing each other and continuously extending in the longitudinal direction along the outer surface of the frame walls, the mounting rails being configured to fasten the frame unit in a heating-ventilation and air-conditioning system.

5. The frame unit according to claim 1, wherein the fasteners of the fastener assembly each comprise a projection rib to engage with the filter element between two neighboring panels in the closed position.

6. The frame unit according to claim 1, wherein each fastener comprises a fastener frame, wherein each fastener frame comprises at least two opposing fastener side walls each having an inner side and an outer side.

7. The frame unit according to claim 6, wherein the fastener frames define a through-going opening.

8. The frame unit according to claim 1, wherein each fastener comprises one or more form locking means.

9. The frame unit according to claim 8, wherein at least two frame walls each comprise one or more form-locking means corresponding to the form locking means of the fasteners and being configured to form a force locking engagement therewith.

10. The frame unit according to claim 1, wherein one or more of the frame walls define at least one notch.

11. The frame unit according to claim 10, wherein each fastener frame comprises one or more fastener projections, wherein the fastener projections and the at least one notch defined by the frame walls are configured such that in the closed position, each fastener projection is accommodated in the at least one notch.

12. The frame unit according to claim 1, wherein the fastener assembly comprises locking clips being arranged at the fasteners and being configured to engage with the outer surface of the frame walls in the longitudinal direction in the closed position.

13. The frame unit according to claim 1, wherein the fastener assembly is configured to retain each opposite end of the filter element in the respective groove.

14. The frame unit according to claim 1, wherein each fastener is pivotably mounted to the frame by a pivot hinge.

15. The frame unit according to claim 1, wherein each fastener is mounted to the inner surface of the frame walls.

16. (canceled)

17. A filter arrangement, the filter arrangement comprising a frame unit according to claim 1 and a filter element (being accommodated within the filter accommodation compartment, wherein the filter element comprises a plurality of pleats, the pleats extending parallel to each other between opposite ends of the filter element in a longitudinal direction, wherein each pleat comprises a fold line defining a pleat tip and a pair of adjacent panels, wherein the filter element is held by the frame unit.

18. The filter arrangement according to claim 17, wherein the fastener assembly retains each of the opposite ends of the filter element in the respective groove.

19. (canceled)

20. A kit of parts comprising a filter arrangement according to claim 17, and one or more filter elements.

21. The frame unit according to claim 8, wherein the one form locking means is arranged on each fastener side wall or on the outer side of each fastener side wall.

22. The frame unit according to claim 10, wherein the at least one notch is arranged above the form locking means of the frame walls.
